(19) United States
(12) Patent Application Publication
(10) Pub. No.: US 2006/0062085 A1
(43) Pub. Date: Mar. 23, 2006

(54) Bottle with timing mechanism

(76) Inventor: Stacy M. Evans, Rome, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/947,115

(22) Filed: Sep. 22, 2004

(51) Int. Cl. G04B 47/00; A61J 11/00; B67D 5/06

(52) U.S. Cl. 368/10; 222/39; 222/23; 215/11.1

(57) ABSTRACT

A bottle having a timing mechanism for indicating the feeding time of a baby, infant, toddler, child, or the like, wherein the timing mechanism comprises three windows for displaying the current time, a time that the bottle was previously dispensed, and an alarm time. The timing mechanism further comprises an hour set button and a minute set button to allow a caregiver to selectively program the timing mechanism.

### TECHNICAL FIELD

The present invention relates generally to beverage containers, and more specifically to a baby bottle having a timing mechanism for indicating the feeding time of an infant or toddler.

### BACKGROUND OF THE INVENTION

A variety of beverage containers and dispensers have been developed for use by babies, infants, toddlers, young children, and the like. Numerous baby bottles, in particular, are currently available and are in wide use. Conventional baby bottles typically include a generally cylindrical vessel and a cap, wherein the vessel is adapted to retain liquid therewithin, and wherein the cap has a nipple provided thereon. The baby bottle and nipple combination effectively regulate the flow of the contents from the bottle, wherein spillage is essentially prevented in the absence of suction. Accordingly, such bottles may be advantageously utilized to feed babies and other children having limited strength, dexterity and/or control.

When caring for babies and young children, it is often necessary to maintain a regular feeding schedule. Infants, in particular, benefit from feeding at predetermined intervals. Unfortunately, it is often difficult for new mothers to track and monitor regularly scheduled feeding times. Intervals extending from the beginning of one feeding to the beginning of the next can be confusing to a new mother, especially given variance in feeding duration.

Although electrical and mechanical timers and alarms are known and could be utilized to track feeding intervals, such timing mechanisms are typically located in areas within a household that are inconvenient, inaccessible, or otherwise unsuitable to enable effective alert notification at feeding time. That is, due to the hectic and often chaotic nature of infant care, it is unsurprisingly difficult to keep baby bottles and timers in the same general vicinity. This problem is exacerbated when caring for numerous children.

Therefore, it is readily apparent that there is a need for a combination bottle and timing mechanism, wherein the on-board timing mechanism enables a caregiver to establish and maintain a regular feeding schedule for a baby by providing convenient access to the time tracking and alert features.

### BRIEF SUMMARY OF THE INVENTION

Briefly described, in a preferred embodiment, the present invention overcomes the above-mentioned disadvantages and meets the recognized need for such a device by providing a bottle having a timer for indicating the feeding time of a baby, infant, toddler, child, or the like.

According to its major aspects and broadly stated, the present invention in its preferred form is a bottle having a body, a pouch, a cap and a timing mechanism. The body is a container that may be grasped by the user, wherein the body possesses a rim for removably securing the pouch and the cap thereto. The removable pouch is positioned within the body, wherein the pouch performs as a vessel for retaining liquids therewithin. The cap is mounted to the rim of the body to seal the contents of the pouch therewithin, wherein the cap possesses a nipple for dispensing such contents therethrough.

The timing mechanism is attached to the body, wherein the timing mechanism comprises three windows, a first window for displaying the current time, a second window for displaying the time that the previous feeding was commenced, and a third window for displaying an alarm time, that is, the time at which a signal should notify of the next scheduled feeding. The timing mechanism further comprises an hour set button and a minute set button to allow a caregiver to selectively program the timing mechanism.

Accordingly, a feature and advantage of the present invention is its ability to effectively regulate and control the flow of the liquid contents stored therewithin.

Another feature and advantage of the present invention is its removable pouch, advantageously separable from the electrical and/or mechanical components of the bottle for cleaning or disposal.

Yet another feature and advantage of the present invention is its ability to function as a timepiece, while also dispensing liquids.

Still another feature and advantage of the present invention is its ability to assist a user in determining or remembering when the next bottle-feeding should begin.

Still yet another feature and advantage of the present invention is its ability to alert a user of the arrival of a predetermined feeding time.

A further feature and advantage of the present invention is its unique integration of the features and advantages of a baby bottle with the features and advantages of a timer and alarm mechanism.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a front view of a bottle according to a preferred embodiment of the present invention, wherein a current time display is set at 9:30 am, a last bottle display is set at 6:00 am, and an alarm time display is set at 1:00 am;

FIG. 2 is a side view of a bottle of FIG. 1, according to a preferred embodiment of the present invention; and

FIG. 3 is a front view of a timing mechanism according to a preferred embodiment of the present invention, wherein a current time display is set at 9:30 am, a last bottle display is set at 6:00 am, and an alarm time display is set at 1:00 am.

### DETAILED DESCRIPTION OF THE PREFERRED AND SELECTED ALTERNATIVE EMBODIMENTS

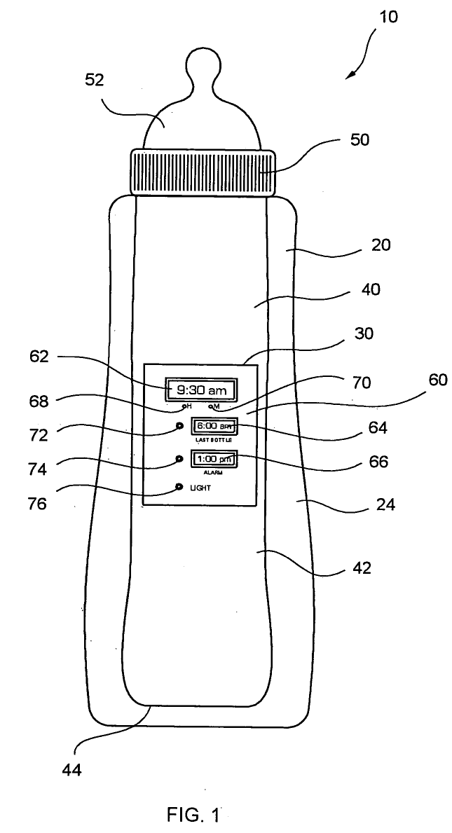

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

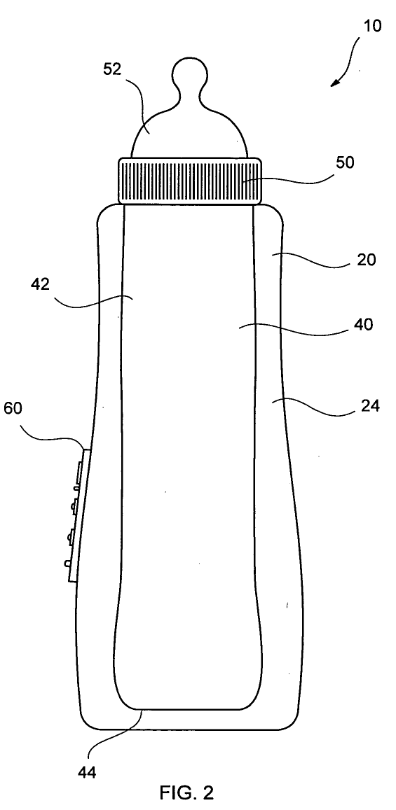

Referring now to FIGS. 1-2, the present invention in a preferred embodiment is bottle 10, wherein bottle 10 comprises body 20, pouch 40, cap 50 and timing mechanism 60. Bottle 10 is preferably utilized for feeding a baby, infant, toddler, child, or the like; however, it is contemplated that bottle 10 could be utilized to feed animals, such as, for exemplary purposes only, primates, pigs, dogs, cats, sheep, cattle, and other livestock. It is further contemplated that bottle 10 could be formed without pouch 40, wherein body 20 could alternatively be formed to receive liquids directly. It is important to understand that the present invention is suitable for utilization on any type of beverage container wherein timekeeping would be beneficial; therefore, while the system and method of the present invention is described conveniently with the preferred utilization on a baby bottle, it is not limited to application or implementation with only such containers.

Preferably, body 20 is generally cylindrical-shaped and contoured, wherein body 20 comprises rim 22 (not shown), peripheral wall 24 and aperture 30. Rim 22 preferably defines circular-shaped orifice 26, wherein rim 22 preferably possesses a threaded lip for removably securing cap 50 thereon, with pouch 40 secured therebetween, as is commonly known within the art. Other types of cap and nipple formations or structures could be utilized without departing from the scope of the present invention.

Body 20 is preferably formed from transparent plastic, although it is recognized that body 20 could be formed from other suitable materials, such as, for exemplary purposes only, metal, metal alloys, paper, glass, polystyrene, rubber, or any other natural or synthetic materials. It is contemplated, in another alternative embodiment, that body 20 could be formed with a solid bottom surface. It is further contemplated, that body 20 could embody other alternatively suitable shapes and sizes, so long as body 20 is capable of receiving cap 50 thereon and retaining liquid contents therewithin, as more fully described below.

Preferably, pouch 40 is a generally elongated vessel capable of retaining liquids therewithin, wherein pouch 40 comprises peripheral wall 42, bottom wall 44 and upper opening 46 (not shown), and wherein peripheral wall 42 is integrally formed to bottom wall 44 to define pouch 40. Preferably, upper opening 46 is secured to rim 22 of body 20 via frictional engagement, as is commonly known with conventional baby bottles, thereby removably securing pouch 40 within body 20. It is contemplated in an alternative embodiment that upper opening 46 of pouch 40 could be attached to rim 22 of body 20 by other suitable means, such as, for exemplary purposes only, adhesives, bands, straps, ties, clamps, clasps, clips, screws, bolts, pins, pegs, threaded engagement, a tab and slot system, or pouch 40 could be integrally formed with body 20. Preferably, however, pouch 40 is removable from body 20, thereby facilitating the disposal or cleaning of pouch 40. Further, although the use of pouch 40 is preferred, bottle 10 could be utilized without a pouch, wherein any shaped body 20 could retained liquids directly therein.

Pouch 40 is preferably formed from transparent plastic material that is generally conformable and preferably resistant to extreme temperatures. It is recognized in an alternative embodiment, however, that pouch 40 could be formed from other suitably appropriate materials.

Preferably, cap 50 is a cylindrically shaped lid that is removably secured to rim 22 of body 20 via threaded engagement, as is commonly known within the art, for securing nipple 52 to body 20 and for sealing the contents of pouch 40 therewithin. Preferably, nipple 52 is centrally disposed within cap 50. Nipple 52 is preferably a conventional baby bottle spout, as is commonly known with the art, for dispensing a controlled amount of liquid therethrough, responsive to suction. Cap 50 is preferably formed from plastic and nipple 52 is preferably formed from rubber, although it is recognized that other suitable materials known within the art may be utilized. It is further recognized that nipple 52 can be of any shape or structure suitable for the intended use.

Although it is preferred that cap 50 is threadedly related to body 20, in an alternate embodiment, cap 50 could be mounted to body 20 via other suitable means, such as, for exemplary purposes only, adhesives, bands, straps, ties, clamps, clasps, clips, screws, bolts, pins, pegs, a tab and slot system, frictional fit, or cap 50 could be integrally formed with body 20. Preferably, however, cap 50 is removable from body 20, thereby facilitating the disposal or cleaning of cap 50. It is also recognized, in another alternative embodiment, that nipple 52 could be affixed to cap 50 via other suitable means, such as, for exemplary purposes only, adhesives, bands, straps, ties, clamps, clasps, clips, screws, bolts, pins, pegs, a tab and slot system, threaded engagement or nipple 52 could be integrally formed with cap 50.

Preferably, timing mechanism 60 is a multifunctional timer and alarm, wherein timing mechanism 60 preferably comprises current time window 62, last bottle window 64, alarm time window 66, hour set button 68, minute set button 70, last bottle set button 72, alarm set button 74 and light actuating button 76. Preferably, timing mechanism 60 is rectangular shaped, wherein timing mechanism 60 is affixed within aperture 30, defined in peripheral wall 24 of body 20, and wherein timing mechanism 60 is permanently secured therewithin via adhesives to prevent accidental removal therefrom by a child. Alternatively, timing mechanism 60 could be secured within an integrally formed timer mount structure defined within body 20, wherein only hour set button 68, minute set button 70, last bottle set button 72, alarm set button 74 and light actuating button 76 could be accessed from peripheral wall 24.

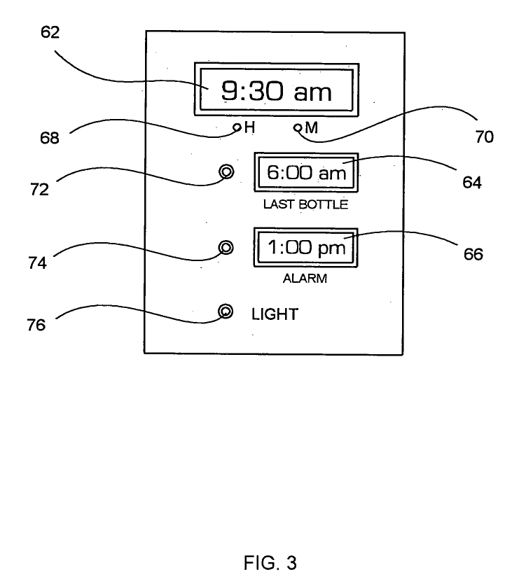

As shown in FIG. 3, current time window 62 is preferably rectangular shaped and is preferably disposed toward an upper center portion of timing mechanism 60. Preferably, hour set button 68 and minute set button 70 are evenly-spaced-apart cylindrical buttons that are centrally disposed below current time window 62, wherein alphanumeric letter “H” is preferably printed proximate hour set button 68, and wherein alphanumeric letter “M” is preferably printed proximate minute set button 70. Preferably, last bottle window 64 is rectangular shaped and is disposed below hour set button 68 and minute set button 70, wherein last bottle set button 72 is cylindrically shaped and is disposed proximate to last bottle window 64. Alphanumeric letters “LAST BOTTLE” are preferably printed below last bottle window 64. Preferably, alarm time window 66 is rectangular shaped and is disposed below the alphanumeric letters “LAST BOTTLE”, wherein alarm set button 74 is cylindrically shaped and is disposed proximate to alarm time window 66 and below last bottle set button 72. Alphanumeric letters “ALARM” are preferably printed below alarm time window 66. Preferably, light actuating button 76 is cylindrically shaped and is disposed below alarm set button 74, wherein alphanumeric letters “LIGHT” are printed proximate light actuating button 76 and below the alphanumeric letters “ALARM”. It is recognized, in an alternative embodiment, that other suitable layouts of windows and buttons may be configured, wherein such buttons and windows could have any shape, and wherein other designations, words and/or symbols could be utilized.

Preferably, current time window 62 displays the current time, last bottle window 64 displays a time that a previous bottle was begun, and alarm time window 66 displays a time that an alert will be activated, as more fully described below. Preferably, current time window 62, last bottle window 64 and alarm time window 66 are battery-powered LED screens that display digital numerals in hours and minutes and “am” or “pm” indicators, as is commonly known within the art. Current time window 62, last bottle window 64 and alarm time window 66 preferably each comprise a light emitting source that may be activated via light actuating button 76 for operating timing mechanism 60 in dark or dimly lit areas.

Preferably, to set the current time in current time window 62, hour set button 68 is actuated to select the appropriate numeral within current time window 62 that demarcates hours “1” through “12”, and minute set button 70 is actuated to select the appropriate numeral within current time window 62 that demarcates minutes “00” to “59”, as is commonly known within the art. Alternatively, military numerals could be included, with a twenty-four hour format.

Preferably, to set the time that a previous bottle was administered in last bottle window 64, hour set button 68 and last bottle set button 72 are actuated simultaneously to select the appropriate numeral within last bottle window 64 that demarcates hours “1” through “12”, and minute set button 70 and last bottle set button 72 are actuated simultaneously to select the appropriate numeral within last bottle window 64 that demarcates minutes “00” to “59”, as is commonly known within the art.

Preferably, to set a predetermined time that an alert will be activated and displayed in alarm time window 66, hour set button 68 and alarm set button 74 are actuated simultaneously to select the appropriate numeral within alarm time window 66 that demarcates hours “1” through “12”, and minute set button 70 and alarm set button 74 are actuated simultaneously to select the appropriate numeral within alarm time window 66 that demarcates minutes “00” to “59”, as is commonly known within the art. Preferably, timing mechanism 60 comprises an audible alert when the time displayed in current time window 62 matches the time displayed in alarm time window 66, as is commonly known within the art. It is recognized in an alternative embodiment, however, that timing mechanism 60 could possess a visual alert, a vibrating alert and/or a combination thereof.

It is recognized in another alternative embodiment, that to set the time that a previous bottle was administered in last bottle window 64, only last bottle set button 72 is actuated, wherein the numerals displayed within last bottle window 64 scroll through the hours and minutes of the day, beginning at “12:00” and ending at “11:59”.

In still another alternative embodiment, to set a predetermined time that an alert will be activated in alarm time window 66, only alarm set button 74 is actuated, wherein the numerals displayed within alarm time window 66 scroll through the hours and minutes of the day, beginning at “12:00” and ending at “11:59”.

In yet another alternate embodiment, timing mechanism 60 could comprise a cover to prevent accidental actuation of hour set button 68, minute set button 70, last bottle set button 72, alarm set button 74 and/or light actuating button 76.

In still yet another alternate embodiment, timing mechanism 60 could comprise a mechanism to selectively activate and deactivate the alert feature, wherein timing mechanism 60 could possess an alarm ON/OFF indicator.

In a further alternate embodiment, current time window 62, last bottle window 64 and alarm time window 66 of timing mechanism 60 could possess AM and/or PM indicators.

In still a further alternate embodiment, current time window 62, last bottle window 64 and alarm time window 66 of timing mechanism 60 could possess hour, minute, and or second hands for indicating the appropriate times.

In yet a further alternative embodiment, timing mechanism 60 could be powered via other suitable means, such as, for exemplary purposed only, solar power.

In still yet a further alternative embodiment, timing mechanism 60 could be attached to body 20 via straps, ties, bands, fasteners, screws, bolts, rivets, dowels, pins, clamps, clasps, clips, threaded engagement, a tab and slot system, hook and loop fasteners, or frictional fit.

In another alternative embodiment, peripheral wall 24 of body 20 could possess bumps, dimples, treads, ridges, grooves and/or indentations to improve a user's grip thereon.

In still another alternative embodiment, body 20 could possess thermal insulative properties.

In yet another alternative embodiment, body 20 could be formed from flexible material to enable a user to squeeze body 20, thereby forcing the dispersal of liquid therefrom.

In still yet another alternative embodiment, peripheral wall 24 of body 20 and/or peripheral wall 42 of pouch 40 could possess incremental line markers to demarcate volume measurements.

In a further alternative embodiment, body 20 could embody a sports bottle and nipple 52 of cap 50 could embody a spout or sipping straw, wherein timing mechanism 60 could be utilized to time exercise durations and/or intervals.

In still a further alternate embodiment, current time window 62 functions as a stopwatch, wherein current time window 62 displays escalating numerals demarcating minutes and hours, and wherein an alert is activated when a predetermined time value is achieved.

In yet a further alternate embodiment, current time window 62 functions as a countdown timer, wherein current time window 62 displays descending numerals demarcating minutes and hours, wherein current time window 62 “counts down” from a predetermined time value (e.g., “4:00”, or four hours) to a time value of zero (i.e., “0:00”), and wherein an alert is activated when a zero time value is achieved.

In still yet a further alternate embodiment, body 20 could possess a feeding time chart situated thereon, wherein the feeding time chart contains suggested feeding intervals and quantities.

In another alternate embodiment, timing mechanism 60 lacks alarm time window 66, wherein alarm set button 74 may be actuated to display the alarm time in current time window 62.

In still another alternate embodiment, timing mechanism 60 is removable from body 20, wherein timing mechanism 60 may be removably secured to the exterior of any beverage container for utilization therewith.

In yet another alternate embodiment, timing mechanism 60 is removable from body 20 to permit a user to wash body 20 without damaging any electrical and/or mechanical components.

In still yet another alternate embodiment, timing mechanism 60 comprises microwave and dishwasher safe materials.

In a further alternate embodiment, actuation of last bottle set button 72 automatically records the current time in last bottle window 64

In still a further alternate embodiment, actuation of a next-feed-time button automatically calculates the next feeding time based on the current time and a user-programmed time interval, wherein the next feeding time is displayed in a next-feed-time window.

In yet a further alternate embodiment, actuation of a next-feed-time button automatically calculates the next feeding time based on the current time and a user-programmed time interval, wherein an alert is activated when the next feeding time is achieved.

In still yet a further alternate embodiment, the present invention further comprises a remote alert signaling unit that may be carried by the caregiver's person, wherein an audible, visible and/or vibrating alert is activated on the remote alert signaling unit when the selected alarm time is achieved.

In another alternate embodiment, the present invention further comprises a lullaby playing mechanism and/or a colorful flashing light display and an ON/OFF button or switch therefor.

In still another alternate embodiment, bottle 10 could be formed from glow-in-the-dark materials.

In yet another alternate embodiment, the present invention further comprises a stopwatch for timing the duration of a feeding occurrence, i.e., the time utilized by a child to finish a bottle.

In still yet another alternate embodiment, the present invention further comprises a memory chip for generating a feeding report, wherein the feeding report may submitted to a doctor or utilized by parents to monitor daycare, babysitter, or other third-party care.

In a further alternate embodiment, timing mechanism 60 comprises current time set button 71, wherein current time set button 71 and hour set button 68 are actuated simultaneously to select the appropriate numeral within current time window 62 that demarcates hours “1” through “12”, and wherein current time set button 71 and minute set button 70 are actuated simultaneously to select the appropriate numeral within current time window 62 that demarcates minutes “00” to “59”.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A container, said container comprising:
at least one vessel for containing liquids; and
at least one timing mechanism carried by said at least one vessel.

2. The container of claim 1, wherein said container further comprises at least one cap.

3. The container of claim 2, further comprising a nipple.

4. The container of claim 1, wherein said at least one timing mechanism comprises a current time display.

5. The container of claim 4, wherein said at least one timing mechanism comprises at least one time set button.

6. The container of claim 1, wherein said at least one timing mechanism comprises a user-controlled time display.

7. The container of claim 6, wherein said at least one timing mechanism comprises at least one time-display set button.

8. The container of claim 1, wherein said at least one timing mechanism comprises an alarm, said alarm selected from a group consisting of an audible alert, a visual alert, a vibrating alert, and a combination thereof, and wherein said at least one timing mechanism comprises an alarm time display.

9. The container of claim 8, wherein said at least one timing mechanism comprises at least one alarm-time selection button.

10. The container of claim 1, further comprising at least one light source.

11. A baby bottle, said baby bottle comprising:
at least one timing mechanism, wherein said at least one timing mechanism comprises an alarm.

12. The baby bottle of claim 11, further comprising a nipple.

13. The baby bottle of claim 11, wherein said at least one timing mechanism displays the current time.

14. The baby bottle of claim 11, wherein said at least one timing mechanism comprises a user-controlled display.

15. The baby bottle of claim 11, wherein said at least one timing mechanism comprises an alarm time display.

16. The baby bottle of claim 11, wherein said alarm comprises an alert, said alert selected from a group consisting of an audible alert, a visual alert, a vibrating alert, and a combination thereof.

17. The baby bottle of claim 11, further comprising at least one light source.

18. A method of monitoring use of a combination beverage container and timer, said method comprising the steps of:
(a) obtaining a combination beverage container and timer, wherein said combination beverage container and timer displays at least one time, said at least one time selected from a group consisting of the current time, a time selected by a user, and an alarm time; and
(b) reading said at least one time, wherein a user will thereby obtain information regarding use of said combination beverage container and timer.

19. The method of claim 18, further comprising the step of programming a selected time, wherein said selected time is a time that said combination beverage container and timer was previously utilized.

20. The method of claim 18, further comprising the step of programming a selected alarm time, wherein said combination beverage container and timer will activate an alert when said selected alarm time is attained.
